(19) United States
(12) Patent Application Publication
(10) Pub. No.: US 2014/0117705 A1
(43) Pub. Date: May 1, 2014

(54) REINFORCEMENT STRUCTURE FOR VEHICLE SLIDE DOOR

(71) Applicant: SUZUKI MOTOR CORPORATION, (US)

(72) Inventors: Hideyuki Tamaki, Shizuoka-Ken (JP); Junya Morita, Shizuoka-Ken (JP); Yukiharu Matsumura, Shizuoka-Ken (JP)

(73) Assignee: SUZUKI MOTOR CORPORATION, Shizuoka-ken (JP)

(21) Appl. No.: 13/852,497

(22) Filed: Mar. 28, 2013

(30) Foreign Application Priority Data
Apr. 23, 2012 (JP) 2012-097904

(51) Int. Cl. B60J 5/04

(52) U.S. Cl. CPC B60J 5/042
USPC 296/146.6

(57) ABSTRACT

A front side of the rear slide door 2 is held with the hook 27 being engaged with the striker 41 when a load from inside of a vehicle interior is applied to the rear slide door 2, upper and lower-side reinforcement members 5 and 6 that are joined to panel surfaces 21a to 21c at the front portion of the door inner panel 21 are provided along an upper-lower direction around the hook 27, a lower portion of the upper-side reinforcement member 5 and an upper portion of the lower-side reinforcement member 6 are joined together in an overlapped state, and a position in the upper-lower direction of a joined portion W where the reinforcement members 5 and 6 are overlap is arranged at a same height as the member portion 24 in front view.

### CROSS-REFERENCE TO RELATED APPLICATION

The present application claims priority from Japanese Patent Application No. 2012-097904 filed Apr. 23, 2012, the disclosure of which is hereby incorporated herein by reference.

### BACKGROUND OF THE INVENTION

The present invention relates to a reinforcement structure for a vehicle slide door which can improve the strength of holding a front side of a rear slide door when a load from inside of a vehicle interior to outside of the vehicle interior is applied to said rear slide door.

Conventionally, rear slide doors which open and close a door opening portion in a vehicle body side surface by sliding along a vehicle longitudinal direction are provided in vehicle body side surfaces of vehicles, and said rear slide door is arranged behind a front door.

In some of the vehicles equipped with said rear slide doors, a hook is provided at a front portion of a door inner panel that constitutes the rear slide door, and a striker is provided projecting corresponding to the hook on a vertical wall surface of a center pillar next to the door opening portion (for example, see Japanese Patent Application Laid-Open No. 2009-143294).

In the vehicles equipped with the rear slide doors as described above, when a load from inside of a vehicle interior to outside of the vehicle interior is applied to the rear slide door, the hook of the door inner panel is engaged with the striker of the center pillar to hold a front side of the rear slide door, so that movement of the rear slide door to a vehicle widthwise outer side is restricted.

### BRIEF SUMMARY OF INVENTION

However, in the structure of the conventional vehicle slide door described above, since a region around a mounting portion of the hook provided at the front portion of the door inner panel that constitutes the rear slide door does not have sufficient rigidity without a reinforcement component having appropriate size and shape and disposed at an appropriate position, there is a risk that a flange portion of the door inner panel will be greatly deformed and an input load point will be displaced from the hook mounting rigid portion of the door inner panel when the load from inside of the vehicle interior to outside of the vehicle interior is applied to the front side of the rear slide door. Particularly, in the door inner panel, a service hole (a work hole) required in installing the hook or the like or mounting a component to the door is provided, and in most cases, is provided adjacent to the hook, so that there is a problem that the rigidity of a region around the service hole is low, and a load input direction is easily displaced.

Moreover, there is a problem that a load stress is concentrated on a corner portion of the service hole, thereby generating a crack in the door inner panel when the input load point is displaced toward a vehicle rear side into the service hole. There is also a risk that the rigidity of the door inner panel is further reduced, and the door inner panel is more greatly deformed when the crack progresses to fracture of the door inner panel.

Also, in the structure of the conventional vehicle slide door, there is a possibility that the entire hook and the entire door inner panel are pressed by the load from inside of the vehicle interior to outside of the vehicle interior, thereby causing such deformation that the hook is rotationally moved. To be more specific, the hook may be deformed such that the entire hook is rotationally moved or the hook angle increases. When such deformation occurs, the hook and the striker are deformed in a direction to be disengaged from each other, so that the engagement therebetween may be loosened (a hook fixing point may be moved due to displacement), or the engagement therebetween may be released. To reduce the deformation of the hook, it is necessary to significantly improve the rigidity of the door inner panel by installing the reinforcement component, inevitably resulting in an increase in the weight and the cost.

The present invention has been made in view of such circumstances, and it is an object thereof to provide a reinforcement structure for a vehicle slide door which can restrict movement of a rear slide door to a vehicle widthwise outer side by providing an upper-side reinforcement member and a lower-side reinforcement member to constitute a portion having higher rigidity than a door inner panel of the rear slide door, suppressing local deformation of a hook and the door inner panel due to a load from inside of a vehicle interior to outside of the vehicle interior by said high-rigid portion to encourage translational deformation of the hook to outside of the vehicle interior, and maintaining engagement between the hook and a striker.

To achieve said object of the conventional technique, the present invention provides a reinforcement structure for a vehicle slide door in which a rear slide door that opens and closes a door opening portion in a vehicle body side surface by sliding along a vehicle longitudinal direction is composed of a door inner panel and a door outer panel, a member portion that extends in the vehicle longitudinal direction is provided in said door inner panel, a hook is provided at a front portion of said door inner panel, a striker is provided on a vertical wall surface of a center pillar next to said door opening portion, and a front side of said rear slide door is held with said hook being engaged with the striker of said center pillar when a load from inside of a vehicle interior to outside of the vehicle interior is applied to said rear slide door, wherein an upper-side reinforcement member and a lower-side reinforcement member that are joined to a panel surface at the front portion of said door inner panel are provided along a vehicle upper-lower direction around said hook, a lower portion of said upper-side reinforcement member and an upper portion of said lower-side reinforcement member are joined together in an overlapped state, and a position in the upper-lower direction of the joined portion where the lower portion of said upper-side reinforcement member and the upper portion of said lower-side reinforcement member are overlap is arranged at a same height as the member portion of said door inner panel in vehicle front view.

In the present invention, the joined portion where the lower portion of said upper-side reinforcement member and the upper portion of said lower-side reinforcement member are overlap is arranged so as to extend in a horizontal direction on the panel surface at the front portion of said door inner panel where said hook is provided, and at least one of said upper-side reinforcement member and said lower-side reinforcement member is joined to the member portion of said door inner panel on an inner side in the vehicle longitudinal direction of said overlapped joined portion.

Also, in the present invention, a hole is provided adjacent to said hook in said door inner panel, and the horizontal joined portion of said upper-side reinforcement member or said lower-side reinforcement member to the member portion of said door inner panel, and a side portion along the upper-lower direction of said upper-side reinforcement member or said lower-side reinforcement member are arranged along a corner portion of said hole in said door inner panel.

Moreover, in the present invention, the side portion along the upper-lower direction of said upper-side reinforcement member or said lower-side reinforcement member is arranged along a flange portion as an upper-lower side of said hole in said door inner panel.

Also, in the present invention, a bead portion is provided so as to extend at a position facing the corner portion of said hole on said upper-side reinforcement member or said lower-side reinforcement member located close to the corner portion of said hole in said door inner panel.

As described above, in the reinforcement structure for a vehicle slide door according to the present invention, the rear slide door that opens and closes the door opening portion in the vehicle body side surface by sliding along the vehicle longitudinal direction is composed of the door inner panel and the door outer panel, the member portion that extends in the vehicle longitudinal direction is provided in said door inner panel, the hook is provided at the front portion of said door inner panel, the striker is provided on the vertical wall surface of the center pillar next to said door opening portion, the front side of said rear slide door is held with said hook being engaged with the striker of said center pillar when the load from inside of the vehicle interior to outside of the vehicle interior is applied to said rear slide door, the upper-side reinforcement member and the lower-side reinforcement member that are joined to the panel surface at the front portion of said door inner panel are provided along the vehicle upper-lower direction around said hook, the lower portion of said upper-side reinforcement member and the upper portion of said lower-side reinforcement member are joined together in the overlapped state, and the position in the upper-lower direction of the joined portion where the lower portion of said upper-side reinforcement member and the upper portion of said lower-side reinforcement member are overlap is arranged at the same height as the member portion of said door inner panel in vehicle front view.

Therefore, in the reinforcement structure of the present invention, the rigidity of the door inner panel is increased by enlarging the reinforcement member, the rigidity of a portion around the hook is increased above that of the door inner panel by the upper-side reinforcement member and the lower-side reinforcement member, and the load applied to the rear slide door from inside of the vehicle interior to outside of the vehicle interior is received by the upper-side reinforcement member and the lower-side reinforcement member as well as the door inner panel around the hook and the member portion thereof, so that deformation around the hook, particularly displacement of a load point and rotational movement of a hook mounting base portion can be prevented. Also, in the reinforcement structure of the present invention, the high-rigid joined portion where the upper-side reinforcement member and the lower-side reinforcement member are overlap is arranged at the same height as the member portion of the door inner panel in vehicle front view, so that the rigidity of the portion receiving the load from inside of the vehicle interior can be improved by a T-shaped intersection formed at the portion receiving the load, translational deformation of the hook to outside of the vehicle interior can be encouraged by suppressing local deformation of the hook and the door inner panel due to the load, and the rotational movement of the hook can be effectively reduced. Moreover, in the reinforcement structure of the present invention, a region around the hook mounting portion is surrounded by the upper-side reinforcement member or the lower-side reinforcement member, so that the engagement with the striker can be maintained in association with the translational deformation of the hook to an outer side by the upper-side reinforcement member and the lower-side reinforcement member, movement of the rear slide door to a vehicle widthwise outer side can be controlled and restricted, and a gap generated between the rear slide door and the vehicle body side surface can be reduced.

Also, in the reinforcement structure of the present invention, the joined portion where the lower portion of said upper-side reinforcement member and the upper portion of said lower-side reinforcement member are overlap is arranged so as to extend in the horizontal direction on the panel surface at the front portion of said door inner panel where said hook is provided, and at least one of said upper-side reinforcement member and said lower-side reinforcement member is joined to the member portion of said door inner panel on the inner side in the vehicle longitudinal direction of said overlapped joined portion, so that the upper and lower reinforcement members have combined rigidity at the joined portion where the lower portion of the upper-side reinforcement member and the upper portion of the lower-side reinforcement member overlap, and the rigidity of the overlapped joined portion can be improved. Moreover, in the reinforcement structure of the present invention, the hook is arranged in the panel surface at the front portion of the door inner panel, the joined portion where the upper and lower reinforcement members are overlap traverses said panel surface, the load point is located at the overlapped joined portion inside of the vehicle interior, and the member portion of the door inner panel that extends in the vehicle longitudinal direction is also joined to the overlapped joined portion.

Accordingly, in the reinforcement structure of the present invention, the load from inside of the vehicle interior is received by the structural portion of the door inner panel, and the high-rigid joined portion where the upper-side reinforcement member and the lower-side reinforcement member are overlap encourages the translational deformation of the hook to the outer side while absorbing said load, so that the deformation of the portion around the hook can be suppressed, and the rotational movement of the hook mounting portion can be reduced. Furthermore, since the upper-side reinforcement member or the lower-side reinforcement member is joined to the member portion of the door inner panel that extends in the vehicle longitudinal direction, such an effect as to transmit and absorb said load can be further improved.

Also, in the reinforcement structure of the present invention, the hole is provided adjacent to said hook in said door inner panel, and the horizontal joined portion of said upper-side reinforcement member or said lower-side reinforcement member to the member portion of said door inner panel, and the side portion along the upper-lower direction of said upper-side reinforcement member or said lower-side reinforcement member are arranged along the corner portion of said hole in said door inner panel, so that even when a load stress from inside of the vehicle interior is concentrated on the corner portion of the hole such as a service hole required in installing the hook or the like or mounting a component to the rear slide door, said load stress can be transmitted to the outer side of the door inner panel and thereby absorbed by use of the high-rigid structural portion, to reduce the occurrence of a crack in the corner portion of the hole.

Also, in the reinforcement structure of the present invention, the side portion along the upper-lower direction of said upper-side reinforcement member or said lower-side reinforcement member is arranged along the flange portion as the upper-lower side of said hole in said door inner panel, so that the rigidity of the portion around the hole having a flange shape can be improved, and the displacement of the load point from inside of the vehicle interior can be decreased. Moreover, since the lower-side reinforcement member joined to the panel surface at the front portion of the door inner panel is formed in an L shape in vehicle upper view so as to be joined to a surface perpendicular to a vehicle width direction, and the load from inside of the vehicle interior is input to the surface perpendicular to the vehicle width direction to press the hook to the outer side, the region around the hook is mainly deformed in a translational fashion to the outer side, and the rotational movement of the hook can be reduced.

Furthermore, in the reinforcement structure of the present invention, the bead portion is provided so as to extend at a position facing the corner portion of said hole on said upper-side reinforcement member or said lower-side reinforcement member located close to the corner portion of said hole in said door inner panel, so that deformation of a region around the bead portion due to the load from inside of the vehicle interior can be suppressed, and even if there occurs a crack in the corner portion of the hole due to the load from inside of the vehicle interior, the crack does not spread and the overall deformation thus does not progress, thereby improving such an effect as to stop the crack from progressing.

### BRIEF DESCRIPTION OF DRAWINGS

FIG. 1 is a perspective view, as viewed from diagonally-backward outside, of a door inner panel of a rear slide door from which a door outer panel is removed in a vehicle to which a reinforcement structure for a vehicle slide door according to an embodiment of the present invention is applied.

FIG. 2 is a perspective view illustrating an enlarged X portion in FIG. 1.

FIG. 3 is a perspective view of the door inner panel in FIG. 1 as viewed from inside of a vehicle interior.

FIG. 4 is an enlarged perspective view illustrating the arrangement relationship of an upper-side reinforcement member, a lower-side reinforcement member, a hook, and a striker provided at a front portion of the door inner panel in the X portion in FIG. 1.

FIG. 5 is a sectional view taken along a line A-A in FIG. 2.

### DETAILED DESCRIPTION OF THE INVENTION

In the following, the present invention will be described in detail based on an embodiment shown in the drawings.

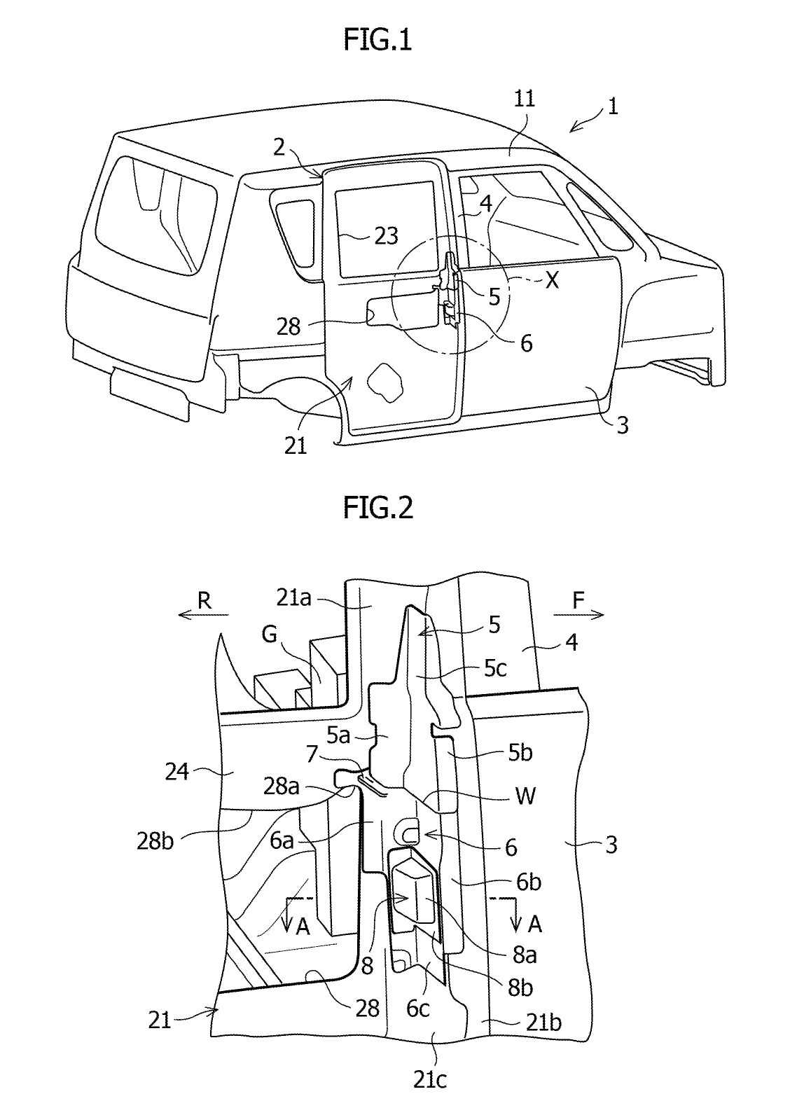

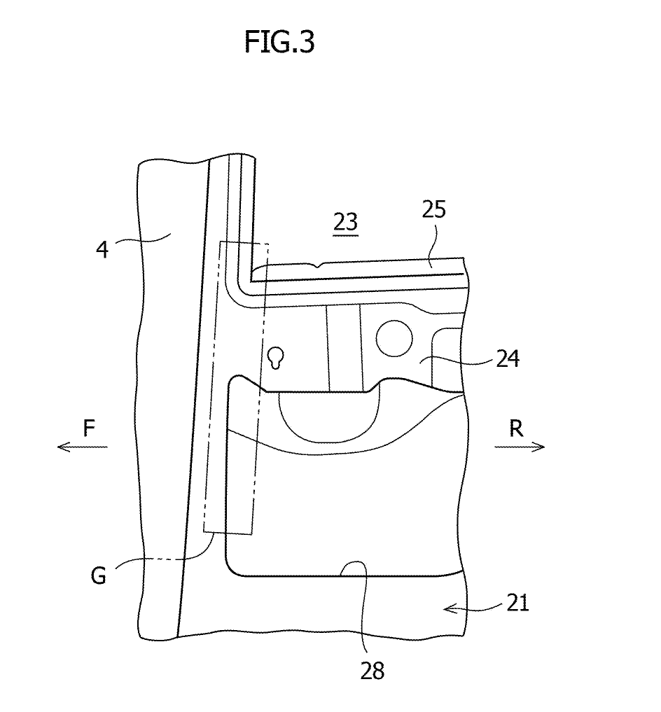

FIGS. 1 to 5 show a reinforcement structure for a vehicle slide door according to the embodiment of the present invention. In FIGS. 2 to 5, the direction of an arrow F indicates a vehicle front side, the direction of an arrow I indicates a direction to the inside of a vehicle interior, the direction of an arrow O indicates a direction to the outside of the vehicle interior, and the direction of an arrow R indicates a vehicle rear side.

As shown in FIGS. 1 to 5, a rear slide door 2 that opens and closes a door opening portion 10 on the vehicle rear side by sliding along a vehicle longitudinal direction is provided in a vehicle body side surface 11 of a vehicle 1 to which the reinforcement structure according to the embodiment of the present invention is applied, and said rear slide door 2 is arranged behind a front door 3 that is rotated on the vehicle rear side.

The rear slide door 2 of the present embodiment is supported so as to be slidable with respect to the vehicle body side surface 11 by upper and lower rollers (not shown) or the like that are arranged to be fitted to upper and lower guide rails (not shown) extending in the vehicle longitudinal direction. Also, the rear slide door 2 is composed of a door inner panel 21 and a door outer panel 22, and is formed into a closed section structure by overlapping and joining together peripheral edge portions of the door inner panel 21 and the door outer panel 22.

As shown in FIGS. 1 to 5, a member portion 24 that is located below a window opening 23 and extends along the vehicle longitudinal direction is provided in the door inner panel 21, and a reinforcement panel 25 that extends in the vehicle longitudinal direction is provided so as to be joined to an outer side surface of said member portion 24. Also, a front portion of the door inner panel 21 is formed to be curved in a substantially crank shape in horizontal section, inner and outer-side panel surfaces 21a and 21b extend in the vehicle longitudinal direction, an intermediate panel surface 21c extends in a vehicle width direction, and an insertion hole 26 having a size and a shape in which a striker described later can be inserted and arranged in a state in which the rear slide door 2 is closed is pierced in the intermediate panel surface 21c at a position corresponding to said striker.

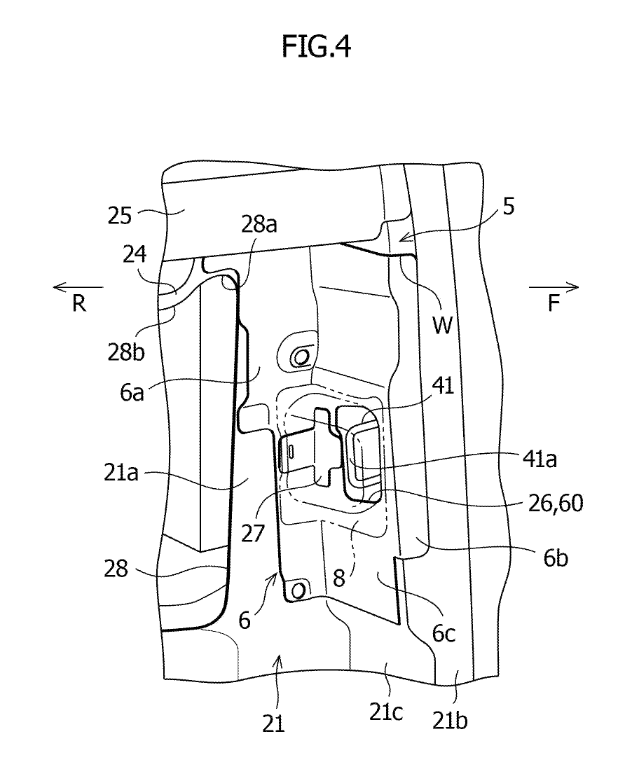

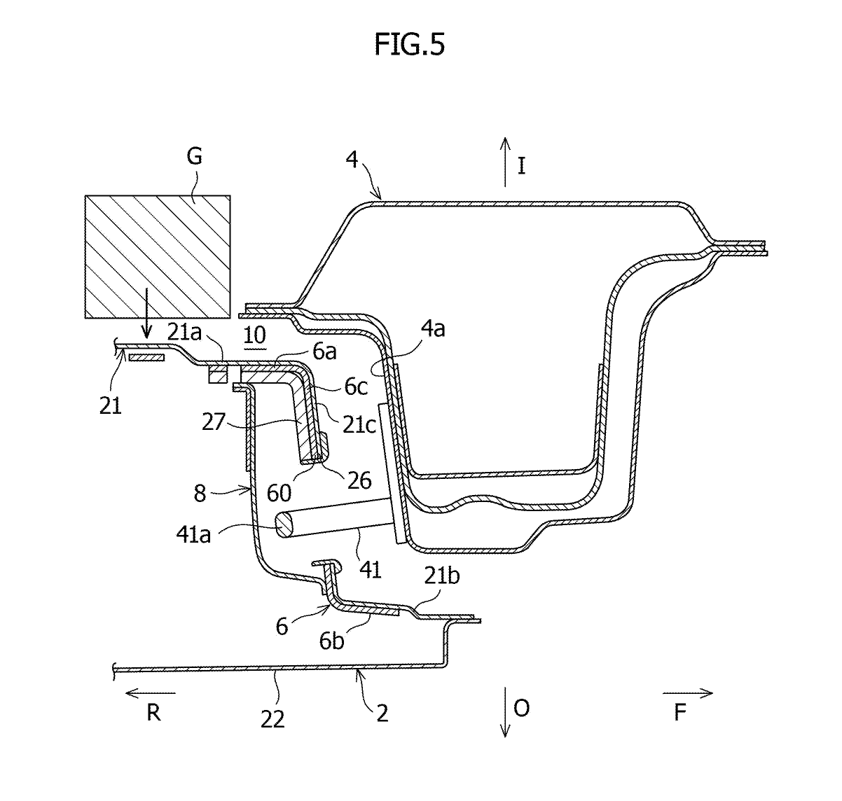

As shown in FIGS. 4 and 5, a hook 27 having an L shape in horizontal section that is arranged along the inner-side panel surface 21a and the intermediate panel surface 21c at the front portion of the door inner panel 21 is joined to the panel surfaces 21a and 21c, and an outer-side distal end portion of said hook 27 is provided projecting to an inner-side peripheral edge portion of the insertion hole 26. A service hole (a work hole) 28 that is required in installing the hook or the like or mounting a component to the rear slide door 2 or the like is provided in the door inner panel 21 at a position adjacent to the hook 27.

Meanwhile, a striker 41 that projects toward the door opening portion 10 is provided on a vertical wall surface 4a of a center pillar (a B pillar) 4 next to the door opening portion 10 on the vehicle rear side as shown in FIGS. 4 and 5. The striker 41 is formed in a square U shape whose opening is located on the vehicle front side as viewed from a lateral side of the vehicle body side surface 11 such that a square U-shaped distal end portion 41a is located inside the rear slide door 2 through the insertion hole 26 in a state in which the rear slide door 2 is closed, and the opening of the striker 41 is arranged so as to face the outer-side distal end portion of the hook 27.

Therefore, when a load from inside of the vehicle interior to outside of the vehicle interior is applied to the rear slide door 2 by a test jig G, the front portion of the door inner panel 21 and the hook 27 move toward outside of the vehicle interior, and an edge end portion of the insertion hole 26 of the door inner panel 21, an edge end portion of a through hole of a lower-side reinforcement member (described later), and the outer-side distal end portion of the hook 27 are engaged with the striker 41 on the center pillar 4 side, so that a front side of the rear slide door 2 of the present embodiment is held by the vehicle body side surface 11 including the center pillar 4.

In the rear slide door 2 of the present embodiment, an upper-side reinforcement member 5 and a lower-side reinforcement member 6 that are joined to the inner and outer-side panel surfaces 21a and 21b and the intermediate panel surface 21c at the front portion of the door inner panel 21 are provided along a vehicle upper-lower direction around the hook 27 as shown in FIGS. 1, 2, and 4, and the upper-side reinforcement member 5 and the lower-side reinforcement member 6 constitute a portion having higher rigidity than the door inner panel 21.

The upper-side reinforcement member 5 and the lower-side reinforcement member 6 are formed to be curved in a substantially crank shape in horizontal section corresponding to the front portion of the door inner panel 21 by using a vertically elongated panel material, respectively have inner and outer-side wall portions 5a, 6a, 5b, and 6b, and intermediate wall portions 5c and 6c, and are arranged along the inner-side panel surface 21a, the intermediate panel surface 21c, and the outer-side panel surface 21b located at said front portion. In the intermediate wall portion 6c of the lower-side reinforcement member 6, a through hole 60 through which the distal end portion 41a of the striker 41 passes is pierced corresponding to the insertion hole 26 of the door inner panel 21.

Also, a lower portion of the upper-side reinforcement member 5 and an upper portion of the lower-side reinforcement member 6 of the present embodiment are arranged so as to be overlap as shown in FIGS. 2 and 4, and in the present embodiment, the lower portion of the upper-side reinforcement member 5 is placed and overlapped on the upper portion of the lower-side reinforcement member 6, and joined thereto in the overlapped state. A position in the upper-lower direction of a joined portion W where the lower portion of the upper-side reinforcement member 5 and the upper portion of the lower-side reinforcement member 6 are overlapped with each other is arranged at the same height as the member portion 24 of the door inner panel 21 in vehicle front view. The arrangement relationship and the joined state between the upper-side reinforcement member 5 and the lower-side reinforcement member 6 as described above provides such a structure as to reinforce a region around the hook 27 located at the front portion of the rear slide door 2.

Moreover, the joined portion W where the lower portion of the upper-side reinforcement member 5 and the upper portion of the lower-side reinforcement member 6 are overlap is arranged so as to horizontally extend on the inner and outer-side panel surfaces 21a and 21b and the intermediate panel surface 21c at the front portion of the door inner panel 21 where the hook 27 is provided, and at least one of the upper-side reinforcement member 5 and the lower-side reinforcement member 6, in the present embodiment the lower-side reinforcement member 6, is joined to the member portion 24 of the door inner panel 21 on an inner side (inside of the vehicle interior) in the vehicle longitudinal direction of the overlapped joined portion W as shown in FIG. 2. Accordingly, the load of the test jig G from inside of the vehicle interior is received by the structural portion of the door inner panel 21, and the high-rigid joined portion W where the upper-side reinforcement member 5 and the lower-side reinforcement member 6 are overlap encourages translational deformation of the hook 27 to an outer side while absorbing said load.

Furthermore, the horizontal joined portion W between the upper-side reinforcement member 5 or the lower-side reinforcement member 6 of the present embodiment, in the present embodiment the lower-side reinforcement member 6, and the member portion 24 of the door inner panel 21, and a side portion along the upper-lower direction of the inner-side wall portion of the upper-side reinforcement member 5 or the lower-side reinforcement member 6, in the present embodiment the inner-side wall portion 6a of the lower-side reinforcement member 6, are arranged along a corner portion 28a of the service hole 28 in the door inner panel 21. Moreover, the side portion along the upper-lower direction of the inner-side wall portion of the upper-side reinforcement member 5 or the lower-side reinforcement member 6, in the present embodiment the inner-side wall portion 6a of the lower-side reinforcement member 6, is arranged along a flange portion 28b as an upper-lower side of the service hole 28 in the door inner panel 21 as shown in FIGS. 2 and 4. Accordingly, the rigidity of a portion around the service hole 28 is improved, and even when a load stress of the test jig G from inside of the vehicle interior is concentrated on the corner portion 28a of the service hole 28, the load stress is transmitted to the outer side of the door inner panel 21 and thereby absorbed, to reduce the occurrence of a crack in the corner portion 28a, and the region around the hook 27 is deformed in a translational fashion, to reduce rotational movement of the hook 27 due to displacement of a load point.

Also, as shown in FIG. 2, a bead portion 7 that projects outward is provided so as to extend at a position facing the corner portion 28a of the service hole 28 along the inner-side wall portion of the upper-side reinforcement member 5 or the lower-side reinforcement member 6 located close to the corner portion 28a of the service hole 28 in the door inner panel 21 of the present embodiment, in the present embodiment the inner-side wall portion 6a of the lower-side reinforcement member 6. To be more specific, the bead portion 7 is arranged so as to extend along the vehicle longitudinal direction and be inclined downward toward the vehicle front side. Because of the existence of the bead portion 7, such a structure as to improve the rigidity of a portion around the bead portion 7, suppress deformation of the portion around the bead portion 7 due to the load of the test jig G from inside of the vehicle interior, and stop the crack generated in the corner portion 28a of the service hole 28 from progressing is obtained.

A door front hook cover 8 that covers the hook 27 and the distal end portion 41a of the striker 41 is mounted to the inner-side wall portion 6a and the intermediate wall portion 6c of the lower-side reinforcement member 6 located around the through hole 60 as shown in FIGS. 2, 4, and 5. To this end, the door front hook cover 8 includes a box portion 8a that bulges outward while opening on a mounting surface side, and in which the hook 27 and the distal end portion 41a of the striker 41 are arranged so as not to be viewed from outside, and a flange piece 8b that is formed projecting to a peripheral portion, and mounted to the inner-side wall portion 6a and the intermediate wall portion 6c, and the door front hook cover 8 is thereby formed into a shape where necessary rigidity is ensured. Since the door front hook cover 8 has necessary rigidity because of such shape, such an effect as to maintain the shape of the portion around the hook 27 in the entire deformation, especially when the deformation progresses, in a case in which the test jig G pushes the door inner panel 21 from inside of the vehicle interior can be obtained.

Next, the operation when the load from inside of the vehicle interior to outside of the vehicle interior is applied to the front side of the rear slide door 2 by the test jig G in the reinforcement structure for the vehicle slide door according to the embodiment of the present invention will be described.

When the test jig G pushes the front side of the rear slide door 2 in the direction of an arrow from a state shown in FIG. 5, the front portion of the door inner panel 21 is pushed toward outside of the vehicle interior, the front portion of the door inner panel 21 and the hook 27 move toward outside of the vehicle interior, and the edge end portion of the insertion hole 26 of the door inner panel 21, the edge end portion of the through hole 60 of the lower-side reinforcement member 6, and the outer-side distal end portion of the hook 27 are engaged with the striker 41 on the center pillar 4 side, so that the front side of the rear slide door 2 is held by the vehicle body side surface 11 including the center pillar 4, and the movement deformation to outside of the vehicle interior is thereby restricted.

When the test jig G further pushes the front portion of the door inner panel 21 toward outside of the vehicle interior in the above state, the load of the test jig G to outside of the vehicle interior is received by the front portion and the member portion 24 of the door inner panel 21 located at the portion around the hook 27, the upper-side reinforcement member 5, the lower-side reinforcement member 6, and the high-rigid joined portion W where the reinforcement members 5 and 6 are overlap, so that local deformation of the door inner panel 21 located around the hook 27 can be suppressed, the displacement of the load point or the rotational movement of the hook mounting base portion can be prevented, and the translational deformation of the hook 27 to outside of the vehicle interior can be encouraged.

Also, even when the test jig G slips into the service hole 28 of the door inner panel 21, there occurs no crack or fracture in the corner portion 28a where the stress is concentrated since a region around said corner portion 28a is covered with the horizontal joined portion W between the lower-side reinforcement member 6 and the member portion 24 of the door inner panel 21, and the side portion along the upper-lower direction of the lower-side reinforcement member 6, and even if there occurs a crack or fracture, the crack or the fracture can be inhibited from progressing and spreading because of the existence of the joined portion W where the reinforcement members 5 and 6 are overlap, and the bead portion 7 added to the lower-side reinforcement member 6.

As described above, in the reinforcement structure for the vehicle slide door according to the embodiment of the present invention, the hook 27 is provided at the front portion of the door inner panel 21 that constitutes the rear slide door 2, the striker 41 is provided on the vertical wall surface 4a of the center pillar 4, the upper-side reinforcement member 5 and the lower-side reinforcement member 6 that are joined to the panel surfaces 21a, 21b, and 21c at the front portion of the door inner panel 21 are provided along the vehicle upper-lower direction around the hook 27, the lower portion of the upper-side reinforcement member 5 and the upper portion of the lower-side reinforcement member 6 are joined together in the overlapped state, and the position in the upper-lower direction of the joined portion W where the lower portion of the upper-side reinforcement member 5 and the upper portion of the lower-side reinforcement member 6 are overlap is arranged at the same height as the member portion 24 of the door inner panel 21 in vehicle front view, so that the rigidity of the door inner panel 21 at the portion around the hook 27 that receives the load of the test jig G from inside of the vehicle interior to outside of the vehicle interior can be improved, the translational deformation of the hook 27 to outside of the vehicle interior can be encouraged by suppressing the local deformation of the hook 27 and the door inner panel 21 due to the load, the engagement between the hook 27 and the striker 41 can be maintained by reducing the rotational movement of the hook 27, and a gap generated between the rear slide door 2 and the vehicle body side surface 11 can be reduced by restricting the movement of the rear slide door 2 to a vehicle widthwise outer side.

Although the embodiment of the present invention has been described above, the present invention is not limited to the aforementioned embodiment, and various modifications and changes may be made based on the technical concept of the present invention.

For example, while the lower portion of the upper-side reinforcement member 5 is placed and overlapped on the upper portion of the lower-side reinforcement member 6, and joined thereto in the overlapped state in the aforementioned embodiment, the upper portion of the lower-side reinforcement member 6 may be placed and overlapped on the lower portion of the upper-side reinforcement member 5, and joined thereto in the overlapped state.

1. A reinforcement structure for a vehicle slide door in which a rear slide door that opens and closes a door opening portion in a vehicle body side surface by sliding along a vehicle longitudinal direction is composed of a door inner panel and a door outer panel, a member portion that extends in the vehicle longitudinal direction is provided in said door inner panel, a hook is provided at a front portion of said door inner panel,
a striker is provided on a vertical wall surface of a center pillar next to said door opening portion, and
a front side of said rear slide door is held with said hook being engaged with the striker of said center pillar when a load from inside of a vehicle interior to outside of the vehicle interior is applied to said rear slide door, wherein
an upper-side reinforcement member and a lower-side reinforcement member that are joined to a panel surface at the front portion of said door inner panel are provided along a vehicle upper-lower direction around said hook,
a lower portion of said upper-side reinforcement member and an upper portion of said lower-side reinforcement member are joined together in an overlapped state, and
a position in the upper-lower direction of the joined portion where the lower portion of said upper-side reinforcement member and the upper portion of said lower-side reinforcement member are overlap is arranged at a same height as the member portion of said door inner panel in vehicle front view.

2. The reinforcement structure for a vehicle slide door according to claim 1, wherein the joined portion where the lower portion of said upper-side reinforcement member and the upper portion of said lower-side reinforcement member are overlap is arranged so as to extend in a horizontal direction on the panel surface at the front portion of said door inner panel where said hook is provided, and at least one of said upper-side reinforcement member and said lower-side reinforcement member is joined to the member portion of said door inner panel on an inner side in the vehicle longitudinal direction of said overlapped joined portion.

3. The reinforcement structure for a vehicle slide door according to claim 2, wherein a hole is provided adjacent to said hook in said door inner panel, and the horizontal joined portion of said upper-side reinforcement member or said lower-side reinforcement member to the member portion of said door inner panel, and a side portion along the upper-lower direction of said upper-side reinforcement member or said lower-side reinforcement member are arranged along a corner portion of said hole in said door inner panel.

4. The reinforcement structure for a vehicle slide door according to claim 1, wherein the side portion along the upper-lower direction of said upper-side reinforcement member or said lower-side reinforcement member is arranged along a flange portion as an upper-lower side of said hole in said door inner panel.

5. The reinforcement structure for a vehicle slide door according to claim 3, wherein a bead portion is provided so as to extend at a position facing the corner portion of said hole on said upper-side reinforcement member or said lower-side reinforcement member located close to the corner portion of said hole in said door inner panel.

6. The reinforcement structure for a vehicle slide door according to claim 2, wherein the side portion along the upper-lower direction of said upper-side reinforcement member or said lower-side reinforcement member is arranged along a flange portion as an upper-lower side of said hole in said door inner panel.

7. The reinforcement structure for a vehicle slide door according to claim 3, wherein the side portion along the upper-lower direction of said upper-side reinforcement member or said lower-side reinforcement member is arranged along a flange portion as an upper-lower side of said hole in said door inner panel.
